(19) United States
(12) Patent Application Publication
(10) Pub. No.: US 2011/0032090 A1
(43) Pub. Date: Feb. 10, 2011

(54) Active Handrest For Haptic Guidance and Ergonomic Support

(76) Inventor: William R. Provancher, Salt Lake City, UT (US)

Correspondence Address: THORPE NORTH & WESTERN, LLP., P.O. Box 1219, SANDY, UT, 84091-1219, US

(21) Appl. No.: 12/937,976

(22) PCT Filed: Apr. 15, 2009
(86) PCT No.: PCT/US09/40623

§ 371 Date: Oct. 14, 2010

Related U.S. Application Data
(60) Provisional application No. 61/045,244, filed on Apr. 15, 2008.

(51) Int. Cl. H04B 3/36

(52) U.S. Cl. 340/407.1

(57) ABSTRACT

An active handrest system (10, 10a) with haptic guidance comprises a haptic interface device (12) operable to be manipulated by a user's fingers (14). The haptic interface device is operatively connected to a movement sensing mechanism (16) capable of sensing motion of the haptic interface device in three dimensions. An active handrest (18) is operatively associated with the haptic interface device, the active handrest including an actuated support platform (20) actuated in at least one degree of freedom. The active handrest is configured to support a hand, wrist, and/or arm of a user and is moveably responsive to motions of the haptic interface device detected by the movement sensing mechanism.

### PRIORITY CLAIM

Priority is claimed of U.S. Provisional Application No. 61/045,244, filed Apr. 15, 2008, which is hereby incorporated herein by reference.

### FIELD OF THE INVENTION

The present invention is directed toward haptic devices for improved acuity and control of limb motion. Therefore, the present invention involves the fields of haptics, ergonomics, and biomechanical control systems.

### BACKGROUND OF THE INVENTION AND RELATED ART

Forbes magazine lists haptics, another name for touch feedback, among the top 10 things that will change the world (and make it a better place). This is not surprising given that researchers keep developing new haptic devices and are finding innovative, useful, and impactful applications for them every day. Particularly relevant has been the development of robotic assistive tools for the medical field, such as the Da Vinci Telesurgical System. While these systems have permitted a significant improvement in dexterity during a surgery over prior laparoscopic techniques, these systems still lack the ergonomic support that is necessary to prevent arm fatigue. These current systems typically include a static elbow rest, but improved support could be provided by a moveable arm or hand rest. Furthermore, the inclusion of a moveable “active handrest” can provide a local means to support precision hand motions that can further improve the effectiveness of these interfaces.

### SUMMARY OF THE INVENTION

In accordance with one aspect, the present invention provides an active handrest system with haptic guidance, including a haptic interface device operable to be manipulated by a user's fingers. The haptic interface device can be operatively connected to a movement sensing mechanism capable of sensing motion of the haptic interface device in three dimensions. An active handrest can be operatively associated with the haptic interface device. The active handrest can include an actuated support platform actuated in at least one degree of freedom. The active handrest can be configured to support a hand, wrist, and/or arm of a user and can be moveably responsive to motion of the haptic interface device detected by the movement sensing mechanism.

In accordance with another aspect of the invention, the system can include a handrest sensing mechanism capable of sensing motion of and forces applied to the active handrest, and a computer interface operatively connected to each of i) the movement sensing mechanism, ii) the active handrest and iii) the handrest sensing mechanism. The computer interface can be configured to receive data corresponding to motion sensed by the movement sensing mechanism and the handrest sensing mechanism to provide corresponding controlled compensation movement to the active handrest based on the motion sensed.

In accordance with another aspect of the invention, a method of providing haptic guidance and support during precision manipulation tasks is provided, included: supporting a hand, wrist or arm of a user on an actuatable support platform; generating position and/or force data relating to a haptic interface device and an active handrest during movement of a hand of a user; calculating a controlled compensation movement corresponding to an input movement control model based on the position signals and/or the force signals; and actuating the support platform to provide the controlled compensation movement.

In accordance with another aspect of the invention, a method of providing support to a wrist or arm during precision manipulation tasks is provided, including: supporting a hand, wrist, or arm of a user on an actuatable support platform; receiving signals from a haptic interface device during movement of a hand of a user; and moving the support platform in response to the signals received to provide support to the hand, wrist, or arm in a different location than an initial location of the actuatable support platform.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention and they are, therefore, not to be considered limiting of its scope. It will be readily appreciated that the components of the present invention, as generally described and illustrated in the figures herein, could be arranged, sized, and designed in a wide variety of different configurations. Nonetheless, the invention will be described and explained with additional specificity and detail through the use of the accompanying drawings in which:

FIG. 1 is an active handrest system in accordance with one embodiment of the present invention;

FIG. 2 is an active handrest system in accordance with another embodiment of the present invention;

FIG. 3a is a simple second order modeling method that can be used in embodiments of the invention;

FIG. 3b is a fourth order model that can be used in embodiments of the invention;

FIG. 3c depicts a method of modeling a human arm;

FIG. 4a is a simple, second order model that can be utilized in embodiments of the invention;

FIG. 4b is a higher order model to represent more complex limb models that can be utilized in embodiments of the invention; and

FIG. 4c is a schematic model illustrating coupling between two degrees of freedom in accordance with one embodiment of the present invention.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

### DEFINITIONS

In describing and claiming the present invention, the following terminology will be used.

The singular forms “a,” “an,” and “the” include plural referents unless the context clearly dictates otherwise. Thus, for example, reference to “a sensor” can include reference to one or more of such devices; when reference is made to “moving” an object, the reference can refer to movement in one or more discrete steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims unless otherwise stated. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Embodiments of the Invention

The present invention provides systems and methods for providing haptic guidance for path following and fine motor tasks. This can include using tactile shear guidance to provide directional information through the grip of a haptic interface device (e.g., a stylus) and augmenting a haptic interface device with an active handrest.

The inventions disclosed herein can be applied across a broad cross-section of applications including neuro- and tele-surgery, hand rehabilitation, and guidance systems for disabled individuals. The present invention uses an active handrest for executing path following and fine fingertip motions. The active handrest can supplement or substitute for traditional force feedback and other haptic guidance techniques, such as virtual fixtures. The present invention can utilize human limb modeling via human subjects testing, and provide at least two modes of supporting the user's hand, wrist and/or forearm while gripping a traditional haptic stylus interface. The first control mode, referred to as supportive mode, will infer the user's optimal handrest position and preemptively move itself to provide continued support based on measured hand motions and handrest reaction forces. The second control mode, referred to as corrective mode, will have the handrest impart forces or motions to the user's wrist/forearm, providing corrective task intervention.

The present invention provides an active handrest that can be employed to provide continuous support and proper ergonomics to the wrist and/or arm, i.e., the handrest follows a user's intended motions, to assist in precision manipulation tasks (i.e., supportive mode). Repositioning a static handrest is often necessary to complete tasks over a large workspace. The present invention provides methods of offering continuous support to assist precision manipulation tasks (i.e., the handrest follows the user's intended motions). Repositioning of the handrest can be based on the desire to keep the motions of the fingers and stylus in the middle of their spatial workspace and can also utilize handrest reaction force information from the Active Handrest Sensing System. This approach can provide an advantage in scenarios where the precision manipulation task requires more than the range of motion provided when the wrist is supported in a fixed position. The active handrest may also be used to intervene and correct motions of a user's hand. Predictive control algorithms for continuously providing ergonomic support and for providing corrective support can be used to adapt the invention to a range of applications. An active handrest may also be augmented with directional shear feedback through the haptic interface device to improve accuracy and performance.

Systems of the present invention can be used in combination with a wide range of current haptic devices and guidance techniques such as the use of virtual fixtures. Through coupled dynamic limb modeling via human subjects testing, the present invention can support the user's hand, wrist and/or forearm while gripping a haptic interface device (e.g., a stylus) and impart forces or motions to the user's arm, wrist, forearm and/or hand to provide corrective task intervention (corrective mode). Within the present description, the terms “handrest”, “wristrest,” and “armrest” can be used interchangeably.

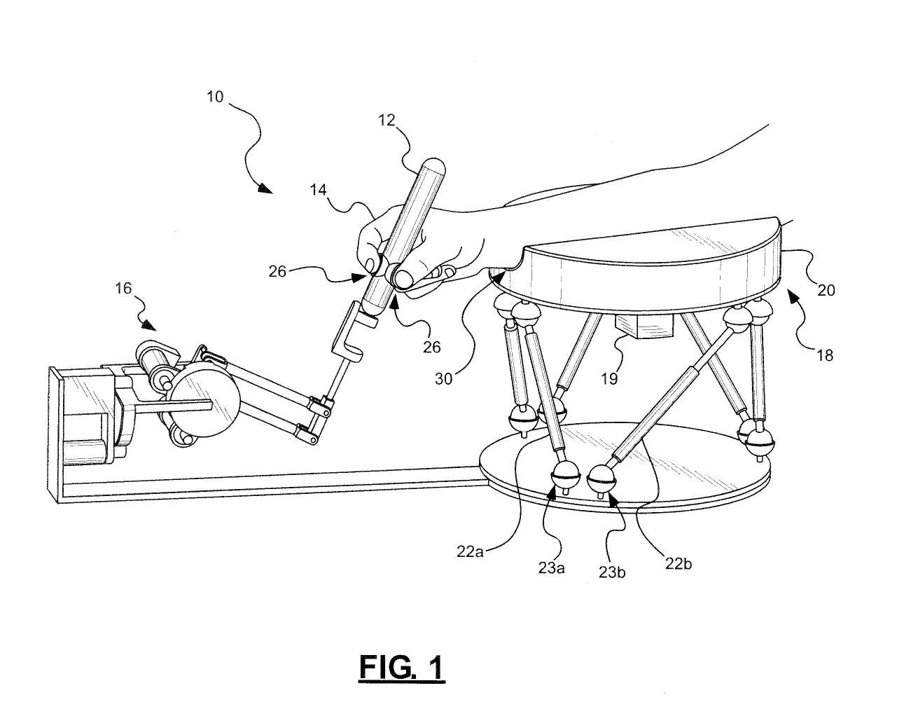

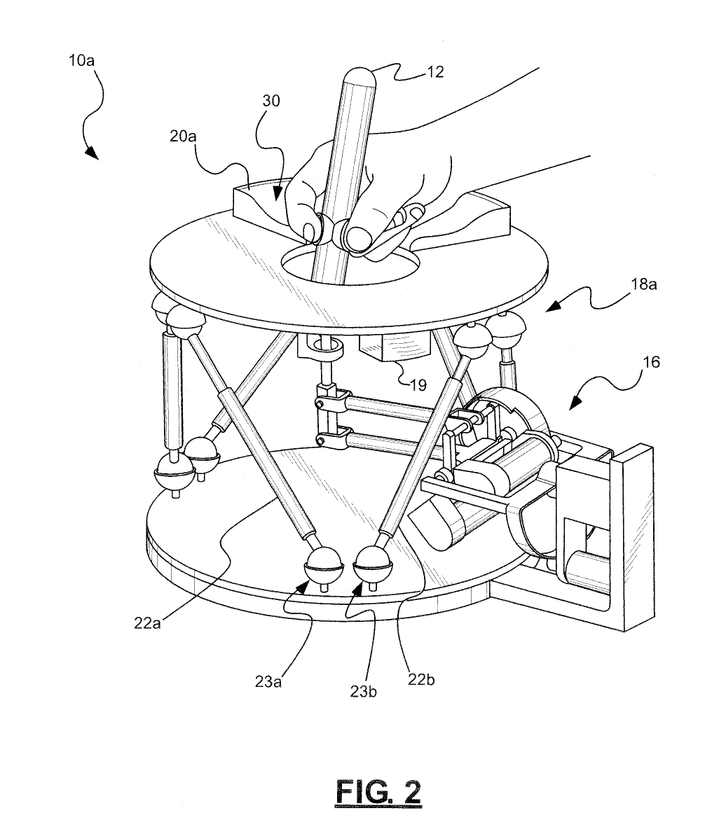

In one aspect of the invention, shown by example in FIGS. 1 and 2, an active handrest system 10, 10a with haptic guidance can be provided. The system can include a haptic interface device 12 that can be operable to be manipulated by a user's fingers 14. The haptic interface device can be operatively connected to a movement sensing mechanism 16 that can be capable of sensing motion of the haptic interface device in three dimensions (through six degrees of freedom).

An active handrest 18 can be operatively associated with the haptic interface device, the active handrest including an actuated support platform 20 that can be actuated in at least one degree of freedom. The active handrest can be configured to support a hand, wrist, and/or arm of a user and can be moveably responsive to motion of the haptic interface device detected by the movement sensing mechanism.

In one aspect of the invention, the active handrest 18 can include a handrest sensing mechanism or system (shown generically at 19) that can be operable to sense or detect movement of the handrest 20, and/or forces and motions applied to the handrest by the user's arm, wrist or hand. A variety of force and/or movement sensors can be utilized in the handrest sensing system, as will be appreciated by one of ordinary skill in the art having possession of this disclosure. For example, various struts 22a, 22b, etc., can include force and/or movement sensors located within or adjacent knuckles 23a, 23b, etc.

In the example shown, the actuated support platform 18 is a parallel manipulator that includes a plurality of struts 22a, 22b, etc., that are each connected to the support platform 20. The struts can be independently controlled, such that the support platform has six degrees of freedom including x-position, y-position, z-position, pitch, roll, and yaw. Control of the struts can be accomplished in a number of manners that would be readily understandable by one of ordinary skill in the art having possession of this disclosure. In one example, the active handrest 18 comprises a Stewart Platform that can be adapted to provide input forces and motions to the forearm of the user.

The haptic interface device 12 can take a variety of forms readily understood by one of ordinary skill in the art having possession of this disclosure. In one example, the haptic interface device is a stylus fitted with one or more tactile shear inputs 26. Discussion of such inputs can be found in U.S. Patent Application Publication No. 20090036212, to the present inventor, which publication is hereby incorporated herein by reference in its entirety. The stylus can be mechanically connected to the movement sensing mechanism. Alternatively, the haptic interface device may be ungrounded and its location could be tracked optically or using other motion detection technologies.

In one example, a commercial hexapod robot (e.g., Physik Instrumente M-840.5PD) can be fitted with an arm support. Stylus/hand motion can be captured using a standard SensAble Technologies PHANToM. While the handrest of the present invention could be designed with fewer degrees of freedom than a Stewart Platform (e.g., one embodiment utilizes a leadscrew driven x-y-z stage), this could limit the motions that could be imparted to the forearm. Such a system could prove effective, however, in particular applications.

The stylus or haptic interface device 12 can include at least one directional shear feedback device oriented to provide shear tactile stimulus to a user's finger to provide tactile feedback to the user. In other words, the stylus includes shear inputs 26 that impart shear forces to pads of the user's fingers to haptically display information to the user. In one embodiment (not shown in detail in the present figures), the haptic interface device includes an actuation system capable of moving a contact pad relative to a base member transversely to provide the shear tactile stimulus to the user's finger.

The provision of shear tactile stimulus to a finger of the user can be sufficient to allow recognition of an intended direction cue and motion response by the user. This can be accomplished, for example, by providing at least two shear feedback devices corresponding to a thumb and index finger of a user while gripping a stylus of the haptic interface device.

Similarly, the movement sensing system 16 can take a variety of forms. In one specific aspect, the movement sensing mechanism is an actuator system having at least six degrees of freedom of motion. Non-limiting examples of suitable commercial actuator systems are described in U.S. Pat. Nos. 5,587,937; 5,625,576; and 5,898,599 and those available from Sensable Technologies as the PHANTOM line of devices.

In application, the support platform 20 (and 20a, in FIG. 2), can include a recessed region 30 sized and shaped to receive and support the hand, wrist, and/or arm of the user. The user's arm, hand or wrist is thus supported by, and can be moved about by, the active handrest 18. The struts 22a, 22b, etc., serve to move the handrest in a multitude of degrees of freedom. As the user's fingers manipulate the stylus 12, the movement sensing mechanism 16 can track movement of the stylus (or the fingers), and correspondingly adjust a position or orientation of the handrest to provide optimal support (in an optimal position and/or orientation) for the fingers to continue the task at hand.

The handrest sensing system 19 can track movement of the handrest to aid in maintaining the user's hand or fingers in a particular position and/or orientation relative to the task being performed. A computer interface (not shown in detail, being readily understood by those of ordinary skill in the art having possession of this disclosure) can be operatively connected to each of: the movement sensing mechanism 16; the active handrest 18; and the handrest sensing mechanism 19. The computer interface can be configured to receive data corresponding to motion and forces sensed by each of these components in order to provide corresponding controlled compensation movement to the active handrest based on the sensed motions and forces.

In the example 10a shown in FIG. 2, the support platform 18a includes a central opening through which the stylus extends and a wrist support 20a oriented on the support platform to receive and support the hand, wrist, and/or arm of the user. Actuating and sensing systems similar to those discussed above can be utilized in this system.

### Active Handrest Control

The present invention also provides various inventive methods for supporting or guiding a user. In one such embodiment, a method of providing haptic guidance and support during precision manipulation tasks is provided, including: supporting a hand, wrist or arm of a user on an actuatable support platform; generating position and/or force data relating to a haptic interface device and an active handrest during movement of a hand of a user; calculating a controlled compensation movement corresponding to an input movement control model based on the position signals and/or the force signals; and actuating the support platform to provide the controlled compensation movement.

While not so required, the controlled compensation movement can be a corrective task intervention based on a set of predetermined models and/or tolerances for the input movement control model (corrective mode). A position of the support platform can be adjusted to center movement in a spatial workspace of the supported limb. In one aspect, the input movement control model can be a spatial skill learning model, a hand rehabilitation model, or a telesurgical procedure model. The input movement control model can include a virtual fixture. The input movement control can further include a shared guidance mode capable of controlling both the haptic interface device and the active handrest.

The input movement control can include a model of hand, wrist, and/or finger dynamics, and movement of the active handrest can be based on a total system transfer function calculated from a plurality of empirical transfer function estimates corresponding to isolated components of a virtual hand-wrist-haptic interface responses. A predictive model can be used to provide continued support during manipulation of the haptic interface device.

### Dynamic Limb Models Used In the Corrective Mode of the Active Handrest

An active handrest can effectively provide corrective hand motions in precision manipulation. The underlying assumption of the “corrective mode” of operation is that knowledge of the forelimb's passive dynamics will enable armrest motions to induce corrective hand motions. Complex motion coupling between the handrest and motion of the grasped haptic interface device can be modeled via system identification.

It is believed that subtle motions of the handrest can provide effective corrections to hand position. To understand the complex motion coupling between the handrest and motion of the grasped stylus interface, detailed system identification of the human wrist can be conducted to create appropriate dynamic models for this control interface. Knowledge of a person's forelimb's transfer function can enable armrest motions to correct hand motions. These corrections are generally affected much faster than a human's voluntary (conscious) response, i.e., less than about 0.10 to 0.15 sec.

The theoretical characterization of the passive dynamics between the forearm and fingertips can form the foundation for controlling active handrest systems in the “corrective mode.” Algorithms for controlling the handrest under multiple modes of operation can be established.

With regard to one particular technological area, one of the greatest challenges in telerobotics is the implementation of a satisfactory interface between the user and the master robot. Both experience and research have shown that force-reflecting systems can significantly increase performance by reducing error, improving precision, conveying information about the environment and improving the subjective “feel” of the system. A simple approach to providing force feedback is to assume that an accurate model of the master device is sufficient when designing a controller. The true quality of haptic interaction, however, is determined by the combined behavior of the master-user system. The user's hand will impart additional mass, damping and stiffness to the system, altering system response and stability characteristics. In the present invention, the additional challenge of influencing the position of a stylus held in the hand by applying forces to the wrist or forearm is addressed. In order to characterize such interactions, a model of the user's hand, wrist and arm to can be used to construct a transfer function between applied forces and stylus movement.

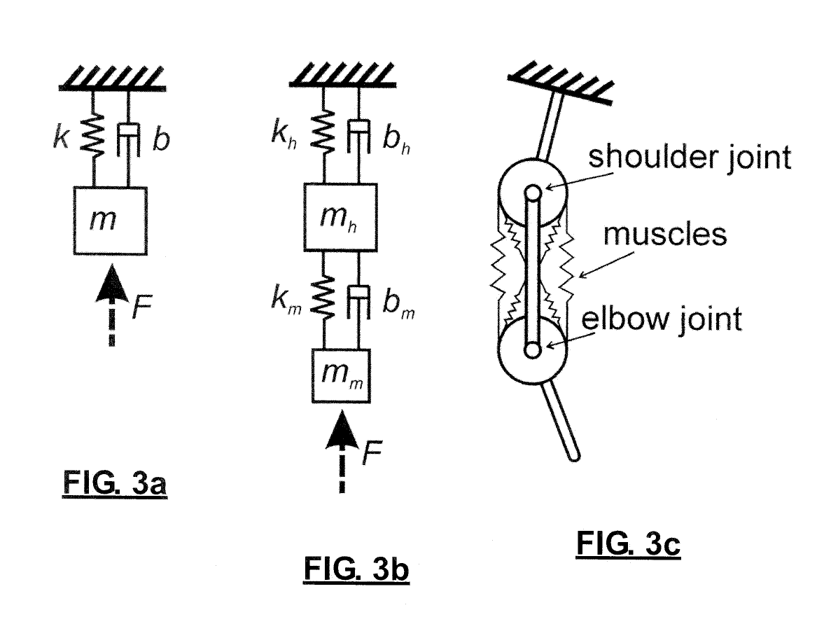

Prior research has been done to construct models of various human joints, generally finding that upper extremity joints can be modeled well as second order, linear time invariant (LTI) systems. As an example, FIG. 3a shows a simple mass-spring-damper second order LTI system typical of those used for joint modeling. FIG. 3a is a simple second order model typical of most joint modeling studies in accordance with one embodiment of the present invention. Mass is indicated m, stiffness k and damping b. FIG. 3b is a fourth order model in accordance with another embodiment of the present invention. The hand is modeled by a second order system, subscript h, coupled to another second order system representing the master robot, with subscript m. In FIG. 3c, the two joint anatomical model used in showing muscles connected only to a single joint and muscles coupling two joints in accordance with one embodiment of the present invention. These or other similar dynamic models can be used to represent the passive dynamics of a user's forearm, wrist, and hand. One can use such models with as few as 1 degree of freedom in designing a corrective mode controller for the active handrest.

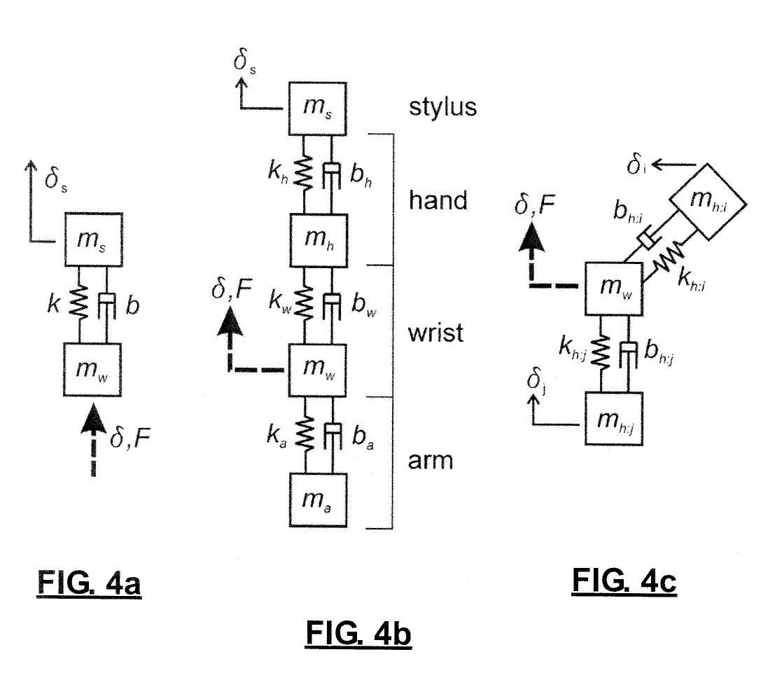

There are several methods that can be employed for system identification of the hand and wrist. One embodiment includes a step or swept sine wave position inputs. Initial modeling can be confined to a single axis of motion and will evaluate whether a simple second order model, as shown in FIG. 4a, or higher order models, as shown in FIG. 4b may be necessary. These models can be used to impart corrective hand motions in the single axis manipulation procedures described herein. FIG. 4a is a simple model of the present handrest system in accordance with one embodiment of the present invention. Displacements δ or Forces F are applied to the wrist (w) and a displacement δs results on the stylus (s). FIG. 4b is a more complex handrest model, capturing dynamics of the arm, wrist, hand, and stylus (a, w, h and s, respectively) in accordance with one embodiment of the present invention. FIG. 4c is a schematic model illustrating coupling between two degrees of freedom (DOFs), i and j in accordance with one embodiment of the present invention. Inputs applied to the wrist (w) and the hand (h) are displaced in 2 coupled DOFs.

Modeling can include the presence of cross-coupling between the axes of motion of the forearm and fingertips/stylus, as schematically shown in FIG. 4c. System inputs along multiple input directions can be applied to the user's forearm and all 6 degrees of freedom of induced hand/stylus motion can be measured. Lower order dynamic models for computational procedures can be used for efficiency, and to reflect the fact that users will have the ability to compensate for stylus motions with their own volitional motions.

These models can be used to impart corrective hand motions in path following procedures.

A variety of the above approaches can be used to develop a simple, low order model, as depicted in FIG. 4a. One unique approach to system identification is where each component of the system (motor, cable, linkage, hand, etc.) is successively isolated and tested with forces of varying frequencies to develop an empirical transfer function estimate (ETFE) of each component, capturing friction and hysteretic characteristics. These ETFEs are then combined to form a total system transfer function. A simple example is shown in FIG. 4b where subscript m indicates the master robot and subscript h indicates the user's hand. The present invention can apply such an approach, isolating the various elements and even the various joints in the hand and arm as depicted in FIG. 4b. The above approaches have been used primarily or exclusively to model simple 1-DOF systems; the multiple-DOF complexity of the present invention will doubtlessly introduce added challenges, such as coupling between DOFs, shown schematically in FIG. 4c.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive.

I claim:

1. An active handrest system with haptic guidance, comprising:
a haptic interface device operable to be manipulated by a user's fingers, the haptic interface device being operatively connected to a movement sensing mechanism capable of sensing motion of the haptic interface device in three dimensions; and
an active handrest, operatively associated with the haptic interface device, the active handrest including an actuated support platform actuated in at least one degree of freedom, the active handrest being configured to support a hand, wrist, and/or arm of a user and being moveably responsive to motions of the haptic interface device detected by the movement sensing mechanism.

2. The system of claim 1, wherein the haptic interface device includes at least one directional shear feedback device oriented to provide shear tactile stimulus to a user's finger to provide tactile feedback to the user.

3. The system of claim 2, wherein the shear feedback device includes an actuation system capable of moving a contact pad relative to a base member transversely to provide the shear tactile stimulus to the user's finger.

4. The system of claim 1, wherein the haptic interface device includes a stylus mechanically connected to the movement sensing mechanism.

5. The system of claim 4, wherein the movement sensing mechanism includes an actuator system having at least six degrees of freedom of motion.

6. The system of claim 1, wherein the actuated support platform is a parallel manipulator having a plurality of struts connected to a support platform, the struts being independently controlled such that the support platform has six degrees of freedom including x-position, y-position, z-position, pitch, roll, and yaw.

7. The system of claim 1, wherein the support platform includes a recessed region sized and shaped to receive and support the hand, wrist, and/or arm of the user.

8. The system of claim 1, wherein the support platform includes a central opening through which the stylus extends and a wrist support oriented on the support platform to receive and support the hand, wrist, and/or arm of the user.

9. The system of claim 1, further comprising:
a handrest sensing mechanism capable of sensing motion of the active handrest, and/or sensing forces applied to the active handrest; and
a computer interface operatively connected to each of i) the movement sensing mechanism, ii) the active handrest and iii) the handrest sensing mechanism, the computer interface being configured to receive data corresponding to motion and/or forces sensed by the movement sensing mechanism and the handrest sensing mechanism and provide corresponding controlled compensation movement to the active handrest based on the sensed motions and/or forces.

10. A method of providing haptic guidance and support during precision manipulation tasks, comprising:
supporting a hand, wrist or arm of a user on an actuatable support platform;
generating position and/or force data relating to a haptic interface device and an active handrest during movement of a hand of a user;
calculating a controlled compensation movement corresponding to an input movement control model based on the position signals and/or the force signals; and
actuating the support platform to provide the controlled compensation movement.

11. The method of claim 10, wherein the controlled compensation movement is a corrective task intervention based on a set of predetermined models and/or tolerances for the input movement control model.

12. The method of claim 10, wherein a position of the support platform is adjusted to center movement in a spatial workspace of the supported limb.

13. The method of claim 10, wherein the input movement control model is a spatial skill learning model, a hand rehabilitation model, or a telesurgical procedure model.

14. The method of claim 10, wherein the input movement control model includes a virtual fixture.

15. The method of claim 14, wherein the input movement control further includes a shared guidance mode capable of controlling both the haptic interface device and the active handrest.

16. The method of claim 10, wherein the input movement control includes a model of hand, wrist, and/or finger dynamics, and wherein movement of the active handrest is based on a total system transfer function calculated from a plurality of empirical transfer function estimates corresponding to isolated components of a virtual hand-wrist-haptic interface responses.

17. The method of claim 10, the input movement control includes a predictive model to provide continued support during manipulation of the haptic interface device.

18. The method of claim 10, further comprising providing shear tactile stimulus to a finger of the user sufficient to allow recognition of an intended direction cue and motion response by the user.

19. The method of claim 18, wherein the shear tactile stimulus is provided by at least two shear feedback devices corresponding to a thumb and index finger of a user while gripping a stylus of the haptic interface device.

20. A method of providing support to a wrist or arm during precision manipulation tasks, comprising:
supporting a hand, wrist, or arm of a user on an actuatable support platform;
receiving signals from a haptic interface device during movement of a hand of a user; and
moving the support platform in response to the signals received to provide support to the hand, wrist, or arm in a different location than an initial location of the actuatable support platform.
